(19) United States
(12) Patent Application Publication
(10) Pub. No.: US 2025/0233717 A1
(43) Pub. Date: Jul. 17, 2025

(54) SINGLE-DCI MULTI-TRP BASED UL TRANSMISSION IN UNIFIED TCI FRAMEWORK

(71) Applicant: LENOVO (BEIJING) LIMITED, BEIJING (CN)

(72) Inventors: BINGCHAO LIU, BEIJING (CN); CHENXI ZHU, FAIRFAX, VA (US); LINGLING XIAO, BEIJING (CN); WEI LING, BEIJING (CN); YI ZHANG, BEIJING (CN)

(21) Appl. No.: 18/730,761

(22) PCT Filed: Jan. 20, 2022
(86) PCT No.: PCT/CN2022/072893

§ 371 Date: Jul. 20, 2024

(51) Int. Cl. H04L 5/00; H04W 72/1268; H04W 72/232

(52) U.S. Cl. CPC H04L 5/0094; H04L 5/0051; H04W 72/1268; H04W 72/232

(57) ABSTRACT

Methods and apparatuses for single-DCI multi-TRP based UL transmission in unified TCI framework are disclosed. In one embodiment, a user equipment (UE) comprises a processor; a memory coupled to the processor; and a receiver coupled to the processor. The processor is configured to cause the UE to: receive, via the receiver, a medium access control (MAC) control element (CE activating at least one Transmission Configuration Indication (TCI) codepoint with two uplink (UL) or joint TCI states; and receive, via the receiver, a downlink control information (DCI indicating one TCI codepoint being activated with two UL or joint TCI states if multiple TCI codepoints are activated with UL or joint TCI states.

### FIELD

The subject matter disclosed herein generally relates to wireless communications, and more particularly relates to methods and apparatuses for single-DCI multi-TRP based UL transmission in unified TCI framework.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Physical Uplink Shared Channel (PUSCH), Downlink Control Information (DCI), transmission reception point (TRP), Sounding Reference Signal (SRS), Medium Access Control (MAC), MAC control element (MAC CE), Physical Uplink Control Channel (PUCCH), Transmission Configuration Indicator (TCI), Radio Resource Control (RRC), Physical Downlink Control Channel (PDCCH), TS (Technical Specification) (TS refers to 3GPP Technical Specification in this disclosure), Pathloss reference signal (PL-RS), quasi-colocation (QCL), reference signal (RS), Physical Downlink Shared Channel (PDSCH), component carrier (CC), control resource set (CORESET), codebook (CB), non-codebook (nCB), band width part (BWP), dynamic grant (DG), configured grant (CG), SRS resource set indication (SRSI), Demodulation Reference Signal (DM-RS), Channel State Information Reference Signal (CSI-RS).

Multi-TRP based UL operation was introduced in NR Release 16 by means of multi-DCI based multi-TRP PUSCH transmission. Furthermore, single-DCI based multi-TRP UL transmission was specified in NR Release 17 to improve robustness of the UL transmission including PUSCH transmission as well as PUCCH transmission.

All multi-TRP based UL transmissions in NR Release 16 and NR Release 17 are based on spatial relation framework specified in NR Release 15. For example, the TX beam or the spatial relation for PUSCH transmission is determined by the spatial relation info configured for the SRS resource used for the PUSCH transmission, and the TX beam or the spatial setting for PUCCH transmission is directly configured for each PUCCH resource by MAC CE.

In order to reduce the beam indication overhead, unified TCI framework was specified in NR Release 17 for single-TRP operation. For UL transmission, the TX beam or the UL TX spatial filter or the spatial relation or the spatial setting for all PUSCH and PUCCH transmissions is determined by the single indicated UL TCI state in separate DL/UL TCI framework or the joint TCI state in joint DL/UL TCI framework. Incidentally, each of the UL TX spatial filter, the spatial relation, and the spatial setting refers to the same concept as the TX beam.

This disclosure targets supporting single-DCI multi-TRP UL transmission with unified TCI framework.

### BRIEF SUMMARY

Methods and apparatuses for single-DCI multi-TRP based UL transmission in unified TCI framework are disclosed.

In one embodiment, a UE comprises a processor and a receiver coupled to the processor, wherein the processor is configured to: receive, via the receiver, an MAC CE activating at least one TCI codepoint with two UL or joint TCI states; and receive, via the receiver, a DCI indicating one TCI codepoint being activated with two UL or joint TCI states if multiple TCI codepoints are activated with UL or joint TCI states. Each of the activated UL or joint TCI state can be associated with a PL-RS for downlink pathloss calculation, and be associated with at least one of UL power control parameter set for PUSCH, UL power control parameter set for PUCCH, and UL power control parameter set for SRS. The processor is further configured to determine a TCI state, apply the determined TCI state and the PL-RS associated with the determined TCI state to each of PUSCH transmission(s), PUCCH transmission(s) and SRS transmission(s), and apply the UL power control parameter set for PUSCH associated with the determined TCI state to the PUSCH transmission(s), apply the UL power control parameter set for PUCCH associated with the determined TCI state to the PUCCH transmission(s), and apply the UL power control parameter set for SRS associated with the determined TCI state to the SRS transmission(s), wherein, the determined TCI state is a first TCI state or a second TCI state of the two UL or joint TCI states activated to the only one TCI codepoint or the indicated one TCI codepoint.

In some embodiment, when only one SRS resource set used for codebook or non-codebook is configured, the first TCI state of the two joint TCI states is determined for all PUSCH transmissions.

In some embodiment, when two SRS resource sets used for codebook or non-codebook are configured, the first TCI state is associated with a first SRS resource set and the second TCI state is associated with a second SRS resource set, and the first TCI state is determined for the PUSCH transmissions transmitted on the SRS port(s) of the SRS resources contained in the first SRS resource set, and the second TCI state is determined for the PUSCH transmissions transmitted on the SRS port(s) of the SRS resources contained in the second SRS resource set. Depending on different types of the PUSCH transmission, the TCI state is determined differently. If the CG configuration of type 1 CG PUSCH transmission contains one group of srs-ResourceIndicator and precodingAndNumberOfLayers, the first TCI state is determined for the type 1 CG PUSCH transmission. If the CG configuration of type 1 CG PUSCH transmission contains two groups of srs-ResourceIndicator and precodingAndNumberOfLayers, the first TCI state is determined for the type 1 CG PUSCH transmission corresponding to a first group of srs-ResourceIndicator and precodingAndNumberOfLayers, and the second TCI state is determined for the type 1 CG PUSCH transmission corresponding to a second group of srs-ResourceIndicator and precodingAndNumberOfLayers. The first TCI state is determined for PUSCH transmission scheduled by DCI without SRS resource set indication field or type 2 CG PUSCH transmission activated by DCI without SRS resource set indication field. For a PUSCH transmission with repetition Type A or repetition Type B that is a dynamic grant PUSCH transmission scheduled by a DCI with SRS resource set indication field or a type 2 configured grant PUSCH transmission activated by a DCI with SRS resource set indication field, the TCI state is determined according to the value indicated by the SRS resource set indication field, wherein, if the PUSCH transmission is with repetition Type A, a repetition of the PUSCH transmission is one repetition of the PUSCH transmission transmitted in one slot, and if the PUSCH transmission is with repetition Type B, a repetition of the PUSCH transmission is a nominal repetition of the PUSCH transmission. When the SRS resource set indication field indicates a value “00”, the first TCI state is determined for all repetitions of the PUSCH transmission; when the SRS resource set indication field indicates a value “01”, the second TCI state is determined for all repetitions of the PUSCH transmission. When the SRS resource set indication field indicates a value “10”: when repetition number K=2, the first TCI state is determined for the first repetition of the PUSCH transmission, and the second TCI state is determined for the second repetition of the PUSCH transmission; when repetition number K>2 and cyclicMapping is configured, the first TCI state is determined for the first repetition of the PUSCH transmission, and the second TCI state is determined for the second repetition of the PUSCH transmission, and the same TCI state mapping pattern continues to the remaining repetitions of the PUSCH transmission; and when repetition number K>2 and sequentialMapping is configured, the first TCI state is determined for the first repetition and the second repetition of the PUSCH transmission, and the second TCI state is determined for the third repetition and the fourth repetition of the PUSCH transmission, and the same TCI state mapping pattern continues to the remaining repetitions of the PUSCH transmission. When the SRS resource set indication field indicates a value “11”: when repetition number K=2, the second TCI state is determined for the first repetition of the PUSCH transmission, and the first TCI state is determined for the second repetition of the PUSCH transmission; when repetition number K>2 and cyclicMapping is configured, the second TCI state is determined for the first repetition of the PUSCH transmission, and the first TCI state is determined for the second repetition of the PUSCH transmission, and the same TCI state mapping pattern continues to the remaining repetitions of the PUSCH transmission; and when repetition number K>2 and sequentialMapping is configured, the second TCI state is determined for the first repetition and the second repetition of the PUSCH transmission, and the first TCI state is determined for the third repetition and the fourth repetition of the PUSCH transmission, and the same TCI state mapping pattern continues to the remaining repetitions of the PUSCH transmission.

In some embodiment, for a PUCCH resource configured to be repeatedly transmitted in two slots or subslots, the first TCI state is determined for a first PUCCH repetition, and the second TCI state is determined for a second PUCCH repetition. In some embodiment, for a PUCCH resource configured to be repeatedly transmitted in four or eight slots or subslots, when cyclicMapping is configured, the first TCI state is determined for a first PUCCH repetition, and the second TCI state is determined for a second PUCCH repetition, and the same TCI mapping pattern continues to the remaining PUCCH repetitions; and when sequentialMapping is configured, the first TCI state is determined for a first PUCCH repetition and a second PUCCH repetition, and the second TCI state is determined for a third PUCCH repetition and a fourth PUCCH repetition, and the same TCI mapping pattern continues to the remaining PUCCH repetitions.

In some embodiment, when only one SRS resource set for CB or nCB is configured, the first TCI state of the two joint TCI states is determined for the one SRS resource set. In some embodiment, when two SRS resource sets for CB or nCB are configured, the first TCI state is determined for a first SRS resource set, and the second TCI state is determined for a second SRS resource set. In some embodiment, for SRS resource sets for beam management or antenna switching without configured or indicated TCI state or spatial relation info, a higher layer parameter is configured per SRS resource set to determine the TCI state, or the first TCI state is determined for all SRS resources within a SRS resource set if no higher layer parameter is configured for the SRS resource set to determine the TCI state.

In another embodiment, a method at a UE comprises: receiving an MAC CE activating at least one TCI codepoint with two UL or joint TCI states; and receiving a DCI indicating one TCI codepoint being activated with two UL or joint TCI states if multiple TCI codepoints are activated with UL or joint TCI states.

In still another embodiment, a base unit comprises a processor and a transmitter coupled to the processor, wherein the processor is configured to: transmit, via the transmitter, an MAC CE activating at least one TCI codepoint with two UL or joint TCI states; and transmit, via the transmitter, a DCI indicating one TCI codepoint being activated with two UL or joint TCI states if multiple TCI codepoints are activated with UL or joint TCI states.

In yet another embodiment, a method of a base unit comprises: transmitting an MAC CE activating at least one TCI codepoint with two UL or joint TCI states; and transmitting a DCI indicating one TCI codepoint being activated with two UL or joint TCI states if multiple TCI codepoints are activated with UL or joint TCI states.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1(a) illustrates an example of determination of TCI state where a DCI with SRSI value of “00” schedules PUSCH transmission with 8 repetitions;

FIG. 1(b) illustrates an example of determination of TCI state where a DCI with SRSI value of “01” schedules PUSCH transmission with 8 repetitions;

FIG. 1(c) illustrates an example of determination of TCI state where a DCI with SRSI value of “10” schedules PUSCH transmission with 8 repetitions and cyclicMapping is configured;

FIG. 1(d) illustrates an example of determination of TCI state where a DCI with SRSI value of “10” schedules PUSCH transmission with 8 repetitions and sequentialMapping is configured;

FIG. 1(e) illustrates an example of determination of TCI state where a DCI with SRSI value of “11” schedules PUSCH transmission with 8 repetitions and cyclicMapping is configured;

FIG. 1(f) illustrates an example of determination of TCI state where a DCI with SRSI value of “11” schedules PUSCH transmission with 8 repetitions and sequentialMapping is configured;

FIG. 2 is a schematic flow chart diagram illustrating an embodiment of a method;

FIG. 3 is a schematic flow chart diagram illustrating an embodiment of another method; and

FIG. 4 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In NR Release 17 unified TCI framework, joint DL/UL TCI or separate DL/UL TCI can be configured for a cell by RRC signaling.

When separate DL/UL TCI is configured, the DL TCI state for DL reception and UL TCI state for UL transmission are separately indicated. For UL TCI state, the source reference signal in the UL TCI provides a reference for determining UL TX spatial filter at least for dynamic-grant or configured-grant based PUSCH transmission and all of dedicated PUCCH resources, which are the PUCCH resources in RRC-connected mode, in a CC. For DL TCI state, the source reference signal(s) (one source reference signal is contained if only the higher layer parameter qcl-Type1 is configured, and two source reference signals are contained if both the higher layer parameter qcl-Type1 and the higher layer parameter qcl_Type2 are configured) in the DL TCI provides QCL information at least for UE-dedicated reception on PDCCH and all the PDSCHs in a CC. Each CORESET is configured by a set time-frequency resource for PDCCH reception. In this situation, a PL-RS is associated with the indicated UL TCI state for path loss calculation. UL power control parameters other than PL-RS (e.g. set of P0 (which configures the target receiving power), alpha (which configures partial pathloss compensation factor) and closed loop index (which indicates which closed power control loop is used when two closed loops are configured)) for PUSCH, PUCCH, and SRS may also be associated with the indicated UL TCI state.

When joint DL/UL TCI is configured, both UL TCI state for UL transmission and DL TCI state for DL reception are determined by a single indicated joint DL/UL TCI state. When the joint DL/UL TCI state is configured, a joint TCI refers to at least a common source reference RS used for determining both the DL QCL information and the UL TX spatial filter. For example, the UL TX beam and the DL RX beam are both determined by the QCL-TypeD RS configured in the indicated joint DL/UL TCI state. In this situation, a PL-RS is associated with the indicated joint DL/UL TCI state for path loss calculation. UL power control parameters other than PL-RS (e.g. set of P0, alpha and closed loop index) for PUSCH, PUCCH and SRS may also be associated with the indicated joint DL/UL TCI state.

A brief introduction of the TCI state is provided as follows:

The UE can be configured with a list of up to M TCI-State configurations to decode PDSCH according to a detected PDCCH with DCI intended for the UE and the given serving cell, where M depends on the UE capability. The TCI-state is configured by the following RRC signaling:

The IE TCI-State associates one or two DL reference signals with a corresponding quasi-colocation (QCL) type.

TCI-State information element

| | |
|---|---|
| TCI-State ::= | SEQUENCE { |
| tci-StateId | TCI-StateId, |
| qcl-Type1 | QCL-Info, |
| qcl-Type2 | QCL-Info |

...
}

| | |
|---|---|
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

Each TCI-State contains parameters for configuring a quasi co-location (QCL) relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command used to map up to 8 TCI states to the codepoints of the DCI field ‘Transmission Configuration Indication’ in one DL BWP of a serving cell. When a UE supports two TCI states in a codepoint of the DCI field ‘Transmission Configuration Indication’ to determine different TX beams for UL transmission, the UE may receive an activation command used to map up to 8 combinations of one or two TCI states to the codepoints of the DCI field ‘Transmission Configuration Indication’, where the one or two TCI states are both used for UL TX beam determination.

In single-DCI based multi-TRP UL transmission, a single DCI can schedule one UL transmission transmitted by multiple panels (e.g. two panels) of a UE to multiple TRPs (e.g. two TRPs). In case of two TRPs, the UL transmission is transmitted from two panels of the UE to the two TRPs by using two different TX beams (TX beam can be also represented by UL TX spatial filter, or spatial relation, or spatial setting), where the two TX beams are determined by two UL TCI states (or two joint TCI states) pointed to by (or activated to) a TCI codepoint, where, when two or more (i.e. more than one, e.g. 2 to 8) TCI codepoints are activated with one or two UL TCI states by a MAC CE (e.g. UL TCI state activation/deactivation MAC CE or joint TCI state activation/deactivation MAC CE), one TCI codepoint is indicated by a TCI field of a DCI from the activated two or more TCI codepoints (i.e. one or two UL TCI states activated to the one TCI codepoint are indicated), and when only one TCI codepoint is activated with one or two UL TCI states by the MAC CE, the TCI codepoint is the only one activated TCI codepoint (i.e. the one or two UL TCI states activated to the only one TCI codepoint are activated). The indicated or activated TCI codepoint may be activated with two UL or joint TCI states (e.g. a first TCI state and a second TCI state) to support single-DCI multi-TRP based UL transmission. Note that in the following description, each of the first TCI state and the second TCI state refers to a UL or joint TCI state that determines a TX beam for UL transmission. Each of the first TCI state and the second TCI state is associated with a PL-RS, which indicates a DL RS, e.g. CSI-RS or SSB, for DL pathloss calculation and is associated with at least one of a UL power control parameter set including P0, alpha and closed loop index for PUSCH transmission, a UL power control parameter set including P0, alpha and closed loop index for PUCCH transmission, and a UL power control parameter set including P0, alpha and closed loop index for SRS transmission.

For example, suppose separate TCI framework is configured for a UE, the following TCI states are mapped (activated by MAC CE) to each TCI codepoint by MAC CE(s):
TCI codepoint 000: UL-TCI-State #1 & UL-TCI-State #12
TCI codepoint 001: UL-TCI-State #23
TCI codepoint 010: UL-TCI-State #32
TCI codepoint 011: UL-TCI-State #24 and DL-TCI-State #2
TCI codepoint 100: UL-TCI-State #45 and DL-TCI-State #45
TCI codepoint 101: UL-TCI-State #55 & UL-TCI-State #60 and DL-TCI-State #32 & DL-TCI-State #65
TCI codepoint 110: DL-TCI-State #64 & DL-TCI-State #85
TCI codepoint 111: DL-TCI-State #120

If the UE receives a DCI format 1_1 containing TCI field with value (or TCI codepoint) 000, two TCI states, i.e., UL-TCI-State #1 and UL-TCI-State #12, are indicated as the UL TCI state.

If the UE receives a DCI format 1_1 containing TCI field with value (or TCI codepoint) 010, only one TCI state, i.e., UL-TCI-State #32 is indicated as the UL TCI state.

If the UE receives a DCI format 1_1 containing TCI field with value (or TCI codepoint) 101, two TCI states, i.e., UL-TCI-State #55 and UL-TCI-State #60, are indicated as the UL TCI state, and two TCI states, i.e., DL-TCI-State #32 and DL-TCI-State #65, are indicated as the DL TCI state.

When two UL TCI states are indicated by the DCI or activated by the MAC CE to one TCI codepoint, how the UL TCI state for each UL transmission (e.g. each repetition of the UL transmission) is determined?

In the following description, to support single-DCI based multi-TRP UL transmission, it is assumed that one TCI codepoint is activated with two UL or joint TCI states (i.e. a MAC CE only activates two UL or joint TCI states to the one TCI codepoint) or indicated (i.e. a MAC CE activates UL or joint TCI state(s) to at least one of two or multiple TCI codepoints, while a DCI indicates one TCI codepoint that is activated with two UL or joint TCI states), and is referred to the activated or indicated TCI codepoint. The two UL or joint TCI states pointed to by (or activated to) the activated or indicated TCI codepoint can be referred to as activated or indicated two UL or joint TCI states, and are further described as “first TCI state” and “second TCI state”, where, the first TCI state refers to a first TCI state of the activated or indicated two UL or joint TCI states, and the second TCI state refers to a second TCI state of the activated or indicated two UL or joint TCI states, unless they are further limited.

A first embodiment relates to the determination of the UL TCI state for each PUSCH transmission (e.g. each repetition of the PUSCH transmission).

Multiple SRS resource sets, each of which contains one or more SRS resources, can be configured for a UE in a BWP of a cell. Different SRS resource sets are configured for different usages. SRS resource set for codebook (CB) is used for codebook based PUSCH transmission, where a set of UL precoders corresponding to different number of antenna ports are specified, which precoder is used for the scheduled PUSCH transmission is based on the UL channel estimation based on the SRS resource used for codebook sending from UE to gNB. SRS resource set for non-codebook (nCB) is used for non-codebook based PUSCH transmission, where the precoder used for PUSCH transmission is computed by the UE based on a received CSI-RS resource. The UE shall calculate one or more precoders and apply the calculated precoders to different SRS resources for non-codebook and send the precoded SRS resources to the gNB. Then the gNB shall indicate one or more SRS resources for the PUSCH transmission, where the precoders applied to the PUSCH transmission should be the same as that used for the indicated SRS resources.

1. When only one SRS resource set used for CB or nCB based UL transmission is configured (e.g. on the BWP of a cell), multi-TRP based PUSCH repetition cannot be supported.

In this condition, if separate DL/UL TCI is configured, the UE shall not expect that the activated or indicated TCI codepoint is activated with two UL TCI states (e.g., not expect that any activated TCI codepoint is activated with two UL TCI states); and if joint DL/UL TCI is configured, when the activated or indicated TCI codepoint is activated with two joint TCI states (e.g. a first joint TCI state and a second joint TCI state), the UE shall apply, to all PUSCH transmissions, the first joint TCI state (to determine the UL TX spatial filter (i.e. TX beam)), the PL-RS associated with the first joint TCI state (used for DL pathloss calculation), and the UL power control parameter set for PUSCH associated with the first joint TCI state (to determine the TX power).

2. When two SRS resource sets used for CB or nCB are configured, multi-TRP based PUSCH repetition can be supported.

If the activated or indicated TCI codepoint is activated with two UL or joint TCI states (e.g. a first TCI state and a second TCI state), each SRS resource set is associated with one of the first TCI state and the second TCI state. For example, the first TCI state is associated with a first SRS resource set (e.g., the SRS resource set for CB or nCB with lower set ID), and the second TCI state is associated with a second SRS resource set (e.g., the SRS resource set for CB or nCB with larger set ID). Accordingly, the first TCI state is associated with all SRS resources contained in the first SRS resource set, and the second TCI state is associated with all SRS resources contained in the second SRS resource set. So, the first TCI state, the PL-RS associated with the first TCI state, and the UL power control parameter set for PUSCH associated with the first TCI state are applied to the PUSCH transmissions transmitted on the SRS port(s) of the SRS resources contained in the first SRS resource set, and the second TCI state, the PL-RS associated with the second TCI state, and the UL power control parameter set for PUSCH associated with the second TCI state are applied to the PUSCH transmissions transmitted on the SRS port(s) of the SRS resources contained in the second SRS resource set.

The PUSCH transmission can be dynamic grant (DG) PUSCH transmission, type 1 configured grant (CG) PUSCH transmission, or type 2 CG PUSCH transmission. DG PUSCH transmission is scheduled by DCI. CG PUSCH is used for semi-static UL traffic, which can be transmitted without dedicated scheduling DCI. Two types of CG PUSCH are specified in NR Release 15. For type 1 CG PUSCH, all the information used for the PUSCH transmission are configured by RRC signaling and the CG PUSCH can be periodically transmitted according to the configured period. For type 2 CG PUSCH, part of information used for the PUSCH transmission is configured by RRC signaling, while the other information is indicated by an activation DCI. Type 2 CG PUSCH can only be periodically transmitted upon receiving the activation DCI. When the UE receives a deactivation DCI to deactivate type 2 CG PUSCH, the corresponding PUSCH shall not be transmitted. Both type 1 CG PUSCH and type 2 CG PUSCH are configured by configured grant PUSCH configuration (i.e., by higher layer parameter configuredGrantConfig IE) and each configuredGrantConfig has an ID. All the scheduling information for Type 1 CG PUSCH transmission are configured by RRC signaling. Multiple Type 1 CG PUSCH transmission(s) can be configured by multiple configuredGrantConfigs. The configured PUSCH transmission(s) are transmitted periodically with the configured period.

When the PUSCH transmission is a Type 1 CG PUSCH transmission, the indication of which SRS resource set is used for the PUSCH transmission depends on how many (i.e. one or two) groups of srs-Resourcelndicator, which indicates one or more SRS resources used for the CG PUSCH transmission, and precodingAndNumberOfLayers, which indicates the precoding matrix used for the CG PUSCH transmission, are configured in RRC signaling configuredGrantConfig that is used to configure the Type 1 CG PUSCH transmission.

If configuredGrantConfig contains only one group of srs-Resourcelndicator and precodingAndNumberOfLayers, the first TCI state, the PL-RS associated with the first TCI state, and the UL power control parameter set for PUSCH associated with the first TCI state are applied to all configured Type 1 CG PUSCH transmissions corresponding to this configuredGrantConfig.

If configuredGrantConfig contains two groups of srs-ResourceIndicator and precodingAndNumberOfLayers, the first TCI state, the PL-RS associated with the first TCI state, and the UL power control parameter set for PUSCH associated with the first TCI state are applied to the configured Type 1 CG PUSCH transmission corresponding to the first group of srs-Resourcelndicator and precodingAndNumberOfLayers, and the second TCI state, the PL-RS associated with the second TCI state, and the UL power control parameter set for PUSCH associated with the second TCI state are applied to the configured Type 1 CG PUSCH transmission corresponding to the second group of srs-ResourceIndicator and precodingAndNumberOfLayers.

For Type 2 CG PUSCH transmission activated by DCI (e.g. DCI format 0_0) without SRS resource set indication (SRSI) field or DG PUSCH transmission scheduled by DCI (e.g. DCI format 0_0) without SRSI field, the first TCI state, the PL-RS associated with the first TCI state, and the UL power control parameter set for PUSCH associated with the first TCI state are applied to the activated Type 2 CG PUSCH transmission or the scheduled DG PUSCH transmission.

When Type 2 CG PUSCH transmission is activated by DCI (e.g. DCI format 0_1 or 0_2) with SRSI field or DG PUSCH transmission is scheduled by DCI (e.g. DCI format 0_1 or 0_2) with SRSI field, the indication of which SRS resource set is used for the PUSCH transmission (Type 2 CG PUSCH transmission or DG PUSCH transmission) is contained in the SRSI field contained in the DCI activating or scheduling the PUSCH transmission. Accordingly, the TCI state to be applied to the PUSCH transmission is determined by the SRSI field contained in the DCI.

Two types of PUSCH repetition schemes, i.e., repetition Type A and repetition Type B, are specified in NR Release 16. For PUSCH repetition Type A, the PUSCH is repeatedly transmitted by K (K>1, e.g. K=2 or 4 or 8) times in K consecutive slots. For PUSCH repetition Type B, the gNB configures the PUSCH transmission with K nominal repetitions. Different from PUSCH repetition Type A, each nominal repetition can be transmitted in one or two consecutive slots. Each nominal repetition consists of one or more actual repetitions, where each actual repetition consists of a consecutive set of all potentially valid symbols that can be used for PUSCH repetition Type B transmission within a slot.

The PUSCH transmission (e.g. Type 2 CG PUSCH transmission or DG PUSCH transmission) with repetition Type A activated or scheduled by DCI format 0_1 or 0_2 is repeatedly transmitted by K (K>1, e.g. K=2 or 4 or 8) times in K consecutive slots. The PUSCH transmission transmitted in each of the K consecutive slots can be referred to as one repetition of the PUSCH transmission. For example, if K=8, the PUSCH transmission is repeatedly transmitted 8 times in 8 consecutive slots. That is, the n^{th} (n is from 1 to K=8) repetition of the PUSCH transmission is transmitted in the n^{th} slot of the 8 consecutive slots.

Depending on the value (or SRSI codepoint) of the SRSI field contained in the DCI activating or scheduling the PUSCH transmission with repetition Type A, the first TCI state or the second TCI state is applied to each repetition of the activated or scheduled PUSCH transmission with repetition Type A. The value (or SRSI codepoint) of the SRSI field can indicate one of “00”, “01”, “10” and “11”.

In all of the following examples, it is assumed that a DCI (e.g. DCI format 1_1) containing TCI field with value (or TCI codepoint) 000 indicates two TCI states, i.e., UL-TCI-State #1 and UL-TCI-State #12, as the UL TCI state. That is, in the examples, the first TCI state is UL-TCI-State #1, and the second TCI state is UL-TCI-State #12.

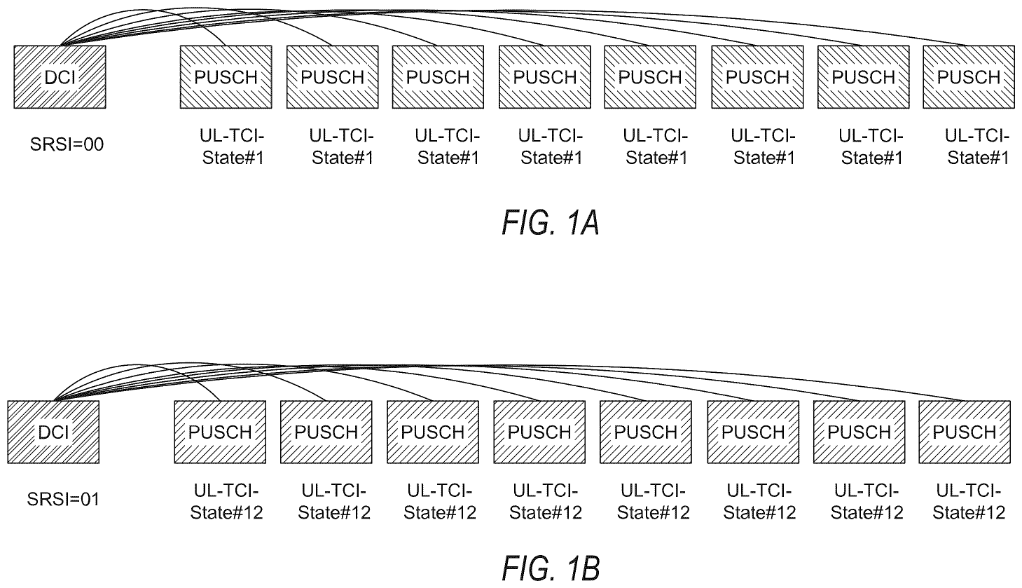

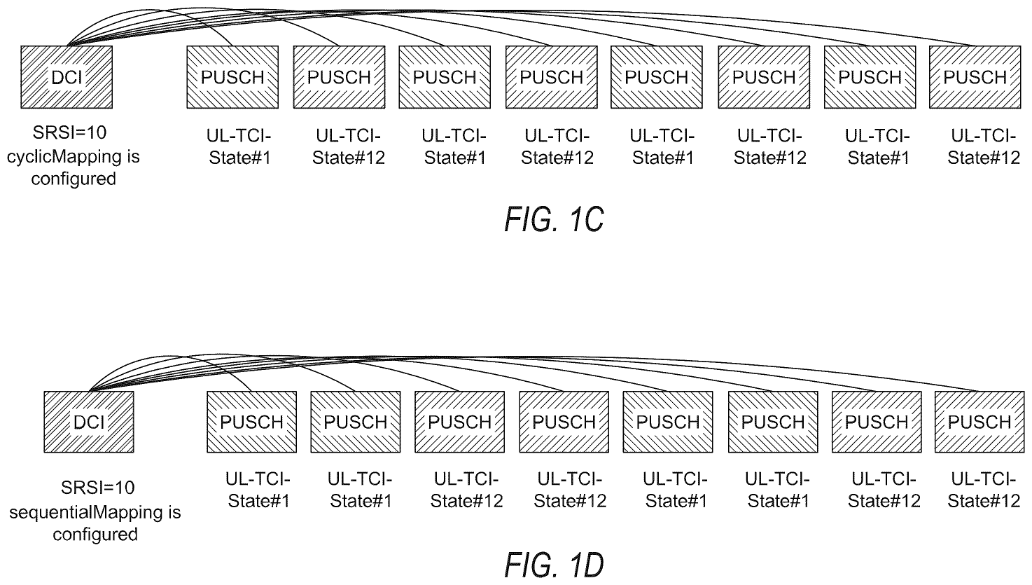

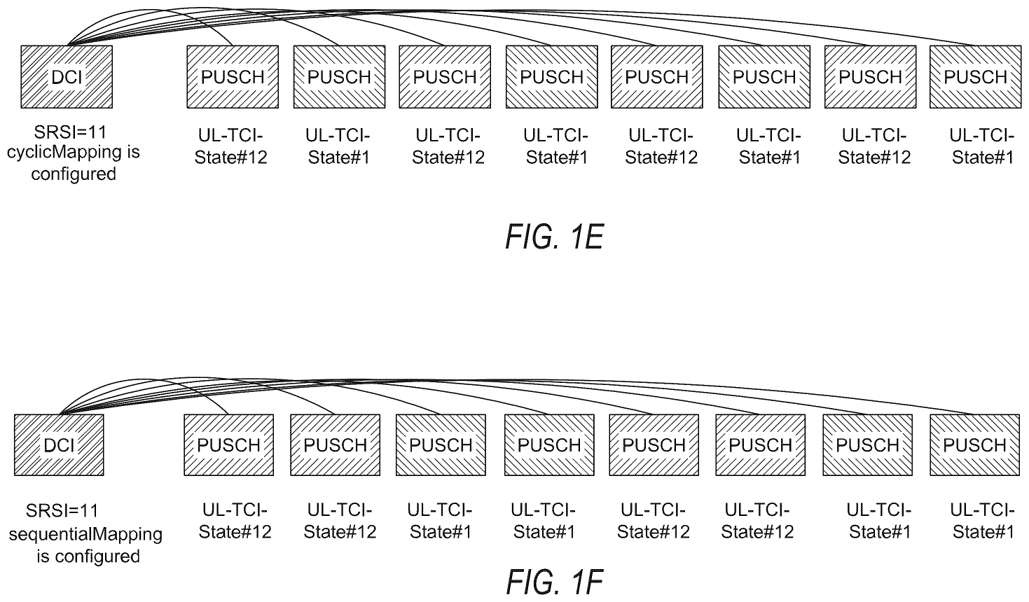

When the SRSI field of the DCI (e.g. DCI format 0_1 or 0_2) indicates a value (or SRSI codepoint) of “00”, the first TCI state, the PL-RS associated with the first TCI state, and the UL power control parameter set for PUSCH associated with the first TCI state are applied to all repetitions of the activated or scheduled PUSCH transmission with repetition Type A. An example is given in FIG. 1(a). A DCI (e.g. DCI format 0_1 or 0_2) containing SRSI value=00 activates or schedules PUSCH transmission with repetition Type A to be transmitted in K=8 consecutive slots. The first TCI state (i.e. UL-TCI-State #1) is determined to be applied to all 8 repetitions of the activated or scheduled PUSCH transmission with repetition Type A.

When the SRSI field of the DCI (e.g. DCI format 0_1 or 0_2) indicates a value (or SRSI codepoint) of “01”, the second TCI state, the PL-RS associated with the second TCI state, and the UL power control parameter set for PUSCH associated with the second TCI state are applied to all repetitions of the activated or scheduled PUSCH transmission with repetition Type A. An example is given in FIG. 1(b). A DCI (e.g. DCI format 0_1 or 0_2) containing SRSI value=01 activates or schedules PUSCH transmission with repetition Type A to be transmitted in K=8 consecutive slots. The second TCI state (i.e. UL-TCI-State #12) is determined to be applied to all 8 repetitions of the activated or scheduled PUSCH transmission with repetition Type A.

When the SRSI field of the DCI (e.g. DCI format 0_1 or 0_2) indicates a value (or SRSI codepoint) of “10”, the TCI state to be applied to each repetition of the activated or scheduled PUSCH transmission with repetition Type A depends on the value of K (the number of repetitions) and the repetition pattern (i.e. cyclicMapping or sequentialMapping).

When K=2, no matter whether cyclicMapping or sequentialMapping is configured, the first TCI state, the PL-RS associated with the first TCI state, and the UL power control parameter set for PUSCH associated with the first TCI state are applied to the first repetition (that is to be transmitted in the first slot of the 2 consecutive slots) of the activated or scheduled PUSCH transmission with repetition Type A, and the second TCI state, the PL-RS associated with the second TCI state, and the UL power control parameter set for PUSCH associated with the second TCI state are applied to the second repetition (that is to be transmitted in the second slot of the 2 consecutive slots) of the activated or scheduled PUSCH transmission with repetition Type A.

When K>2 (e.g. K=4 or 8) and cyclicMapping is configured, the first TCI state, the PL-RS associated with the first TCI state, and the UL power control parameter set for PUSCH associated with the first TCI state are applied to the first repetition (that is to be transmitted in the first slot of the K consecutive slots) of the activated or scheduled PUSCH transmission with repetition Type A, and the second TCI state, the PL-RS associated with the second TCI state, and the UL power control parameter set for PUSCH associated with the second TCI state are applied to the second repetition (that is to be transmitted in the second slot of the K consecutive slots) of the activated or scheduled PUSCH transmission with repetition Type A, and the same TCI state mapping pattern continues to the remaining repetitions of the activated or scheduled PUSCH transmission with repetition Type A (e.g. when K=4 or 8). FIG. 1(c) illustrates an example. A DCI (e.g. DCI format 0_1 or 0_2) containing SRSI value=10 schedules PUSCH transmission with repetition Type A to be transmitted in K=8 consecutive slots with cyclicMapping being configured. The first TCI state (i.e. UL-TCI-State #1) is determined to be applied to the first repetition of the scheduled PUSCH transmission with repetition Type A, and the second TCI state (i.e. UL-TCI-State #12) is determined to be applied to the second repetition of the scheduled PUSCH transmission with repetition Type A. In addition, for the remaining repetitions (the third to the eighth repetitions in this example), the first TCI state (i.e. UL-TCI-State #1) and the second TCI state (i.e. UL-TCI-State #12) are determined to be applied to the third and the fourth repetitions, the fifth and the sixth repetitions, and the seventh and the eighth repetitions (i.e. in a cyclic manner).

When K>2 (e.g. K=4 or 8) and sequentialMapping is configured, the first TCI state, the PL-RS associated with the first TCI state, and the UL power control parameter set for PUSCH associated with the first TCI state are applied to the first repetition and the second repetition (that are to be transmitted in the first slot and the second slot of the K consecutive slots) of the activated or scheduled PUSCH transmission with repetition Type A, and the second TCI state, the PL-RS associated with the second TCI state, and the UL power control parameter set for PUSCH associated with the second TCI state are applied to the third repetition and the fourth repetition (that are to be transmitted in the third slot and the fourth slot of the K consecutive slots) of the activated or scheduled PUSCH transmission with repetition Type A, and the same TCI state mapping pattern continues to the remaining repetitions of the activated or scheduled PUSCH transmission with repetition Type A (e.g. when K=8). FIG. 1(d) illustrates an example. A DCI (e.g. DCI format 0_1 or 0_2) containing SRSI value=10 schedules PUSCH transmission with repetition Type A to be transmitted in K=8 consecutive slots with sequentialMapping being configured. The first TCI state (i.e. UL-TCI-State #1) is determined to be applied to the first repetition and the second repetition of the scheduled PUSCH transmission with repetition Type A, and the second TCI state (i.e. UL-TCI-State #12) is determined to be applied to the third repetition and the fourth repetition of the scheduled PUSCH transmission with repetition Type A. In addition, for the remaining repetitions (the fifth to the eighth repetitions in this example), the first TCI state (i.e. UL-TCI-State #1) is determined to be applied to the fifth repetition and the sixth repetition of the scheduled PUSCH transmission with repetition Type A, and the second TCI state (i.e. UL-TCI-State #12) is determined to be applied to the seventh repetition and the eighth repetition of the scheduled PUSCH transmission with repetition Type A.

When the SRSI field of the DCI (e.g. DCI format 0_1 or 0_2) indicates a value (or SRSI codepoint) of “11”, the TCI state to be applied to each repetition of the activated or scheduled PUSCH transmission with repetition Type A depends on the value of K (the number of repetitions) and the repetition pattern (i.e. cyclicMapping or sequentialMapping).

When K=2, no matter whether cyclicMapping or sequentialMapping is configured, the first TCI state, the PL-RS associated with the first TCI state, and the UL power control parameter set for PUSCH associated with the first TCI state are applied to the second repetition (that is to be transmitted in the second slot of the 2 consecutive slots) of the activated or scheduled PUSCH transmission with repetition Type A, and the second TCI state, the PL-RS associated with the second TCI state, and the UL power control parameter set for PUSCH associated with the second TCI state are applied to the first repetition (that is to be transmitted in the first slot of the 2 consecutive slots) of the activated or scheduled PUSCH transmission with repetition Type A.

When K>2 (e.g. K=4 or 8) and cyclicMapping is configured, the second TCI state, the PL-RS associated with the second TCI state, and the UL power control parameter set for PUSCH associated with the second TCI state are applied to the first repetition (that is to be transmitted in the first slot of the K consecutive slots) of the activated or scheduled PUSCH transmission with repetition Type A, and the first TCI state, the PL-RS associated with the first TCI state, and the UL power control parameter set for PUSCH associated with the first TCI state are applied to the second repetition (that is to be transmitted in the second slot of the K consecutive slots) of the activated or scheduled PUSCH transmission with repetition Type A, and the same TCI state mapping pattern continues to the remaining repetitions of the activated or scheduled PUSCH transmission with repetition Type A (e.g. when K=4 or 8). FIG. 1(e) illustrates an example. A DCI (e.g. DCI format 0_1 or 0_2) containing SRSI value=11 schedules PUSCH transmission with repetition Type A to be transmitted in K=8 consecutive slots with cyclicMapping being configured. The second TCI state (i.e. UL-TCI-State #12) applies to the first repetition of the scheduled PUSCH transmission with repetition Type A, and the first TCI state (i.e. UL-TCI-State #1) applies to the first repetition of the scheduled PUSCH transmission with repetition Type A. In addition, for the remaining repetitions (the third to the eighth repetitions in this example), the second TCI state (i.e. UL-TCI-State #12) and the first TCI state (i.e. UL-TCI-State #1) are determined to be applied to the third and the fourth repetitions, the fifth and the sixth repetitions, and the seventh and the eighth repetitions (i.e. in a cyclic manner).

When K>2 (e.g. K=4 or 8) and sequentialMapping is configured, the second TCI state, the PL-RS associated with the second TCI state, and the UL power control parameter set for PUSCH associated with the second TCI state are applied to the first repetition and the second repetition (that are to be transmitted in the first slot and the second slot of the K consecutive slots) of the activated or scheduled PUSCH transmission with repetition Type A, and the first TCI state, the PL-RS associated with the first TCI state, and the UL power control parameter set for PUSCH associated with the first TCI state are applied to the third repetition and the fourth repetition (that are to be transmitted in the third slot and the fourth slot of the K consecutive slots) of the activated or scheduled PUSCH transmission with repetition Type A, and the same TCI state mapping pattern continues to the remaining repetitions of the activated or scheduled PUSCH transmission with repetition Type A (e.g. when K=8). FIG. 1(f) illustrates an example. A DCI (e.g. DCI format 0_1 or 0_2) containing SRSI value=11 schedules PUSCH transmission with repetition Type A to be transmitted in K=8 consecutive slots with sequentialMapping being configured. The second TCI state (i.e. UL-TCI-State #12) applies to the first repetition and the second repetition of the scheduled PUSCH transmission with repetition Type A, and the first TCI state (i.e. UL-TCI-State #1) applies to the third repetition and the fourth repetition of the scheduled PUSCH transmission with repetition Type A. In addition, for the remaining repetitions (the fifth to the eighth repetitions in this example), the second TCI state (i.e. UL-TCI-State #12) is determined to be applied to the fifth repetition and the sixth repetition of the scheduled PUSCH transmission with repetition Type A, and the first TCI state (i.e. UL-TCI-State #1) is determined to be applied to the seventh repetition and the eighth repetition of the scheduled PUSCH transmission with repetition Type A.

The PUSCH transmission (e.g. Type 2 CG PUSCH transmission or DG PUSCH transmission) with repetition Type B activated or scheduled by DCI format 0_1 or 0_2 is repeatedly transmitted by K (K>1, e.g. K=2 or 4 or 8) times in K nominal repetitions.

For PUSCH transmission with repetition Type B, the TCI state applied to each of the nominal PUSCH repetitions follows the same determination as TCI state applied to each of the repetitions of the PUSCH transmission with repetition Type A by considering nominal repetitions instead of repetitions (each of which is transmitted in a slot).

A second embodiment relates to the determination of the UL TCI state for each PUCCH transmission (e.g. each repetition of the PUCCH transmission).

If a UE is configured to transmit a PUCCH transmission in N_{PUCCH}^{repeat}>1 slots or subslots using a PUCCH resource, and the one activated or indicated TCI codepoint is activated with two UL or joint TCI states (e.g. a first TCI state and a second TCI state), multi-TCI based PUCCH repetition can be supported.

For PUCCH scheme 1 (i.e., inter-slot repetition with repetition number 2, 4, or 8), the TCI state to be applied to each repetition of the scheduled PUCCH transmission with repetition depends on the repetition number N_{PUCCH}^{repeat} (i.e. 2, 4, 8) and the repetition pattern (i.e. cyclicMapping or sequentialMapping).

When N_{PUCCH}^{repeat}=2, no matter whether cyclicMapping or sequentialMapping is configured, the first TCI state, the PL-RS associated with the first TCI state, and the UL power control parameter set for PUCCH associated with the first TCI state are applied to the first repetition of the scheduled PUCCH transmission with repetition in PUCCH scheme 1, and the second TCI state, the PL-RS associated with the second TCI state, and the UL power control parameter set for PUCCH associated with the second TCI state are applied to the second repetition of the scheduled PUCCH transmission with repetition in PUCCH scheme 1.

When N_{PUCCH}^{repeat}=4 or 8 and cyclicMapping is configured, the first TCI state, the PL-RS associated with the first TCI state, and the UL power control parameter set for PUCCH associated with the first TCI state are applied to the first repetition of the scheduled PUCCH transmission with repetition in PUCCH scheme 1, and the second TCI state, the PL-RS associated with the second TCI state, and the UL power control parameter set for PUCCH associated with the second TCI state are applied to the second repetition of the scheduled PUCCH transmission with repetition in PUCCH scheme 1, and the same TCI state mapping pattern continues to the remaining repetitions of the scheduled PUCCH transmission with repetition in PUCCH scheme 1.

When N_{PUCCH}^{repeat}=4 or 8 and sequentialMapping is configured, the first TCI state, the PL-RS associated with the first TCI state, and the UL power control parameter set for PUCCH associated with the first TCI state are applied to the first repetition and the second repetition of the scheduled PUCCH transmission with repetition in PUCCH scheme 1, and the second TCI state, the PL-RS associated with the second TCI state, and the UL power control parameter set for PUCCH associated with the second TCI state are applied to the third repetition and the fourth repetition of the scheduled PUCCH transmission with repetition in PUCCH scheme 1, and the same TCI state mapping pattern continues to the remaining repetitions (e.g. N_{PUCCH}^{repeat}=8) of the scheduled PUCCH transmission with repetition in PUCCH scheme 1.

For PUCCH scheme 3 (i.e. intra-slot repetition with repetition number 2), the first TCI state, the PL-RS associated with the first TCI state, and the UL power control parameter set for PUCCH associated with the first TCI state are applied to the first repetition of the scheduled PUSCH transmission with repetition in PUCCH scheme 3, and the second TCI state, the PL-RS associated with the second TCI state, and the UL power control parameter set for PUCCH associated with the second TCI state are applied to the second repetition of the scheduled PUCCH transmission with repetition in PUCCH scheme 3.

A third embodiment relates to the determination of the UL TCI state for each SRS transmission.

For SRS resource set used for CB or nCB and without configured TCI state or spatial relation info, the determination of the UL TCI state for each SRS transmission is as follows.

When only one SRS resource set for CB or nCB is configured, if separate DL/UL TCI is configured, the UE shall not expect that the activated or indicated TCI codepoint is activated with two UL TCI states (e.g., not expect that any TCI codepoint is activated with two UL TCI states); and if joint DL/UL TCI is configured, when the activated or indicated TCI codepoint is activated with two joint TCI states (e.g., a first joint TCI state and a second joint TCI state), the first joint TCI state, the PL-RS associated with the first joint TCI state, and the UL power control parameter set for SRS associated with the first joint TCI state shall be applied to the one SRS resource set if the gNB indicates that the SRS resources contained in the one SRS resource set share the activated or indicated TCI state used for PUSCH and/or PUCCH transmissions.

When two SRS resource sets for CB or nCB are configured and two UL or joint TCI states are indicated by the DCI, when the activated or indicated TCI codepoint is activated with two joint or UL TCI states (e.g. a first TCI state and a second TCI state), the first TCI state, the PL-RS associated with the first TCI state, and the UL power control parameter set for SRS associated with the first TCI state are applied to a SRS resource set, and the second TCI state, the PL-RS associated with the second TCI state and the UL power control parameter set for SRS associated with the second TCI state are applied to a second SRS resource set, if the gNB indicates that the SRS resources contained in each SRS resource set share the activated or indicated TCI state used for PUSCH and/or PUCCH transmissions.

For SRS resource sets for beam management or antenna switching, if there is no configured or indicated TCI state or spatial relation info, a higher layer parameter is configured per SRS resource set to indicate which TCI state is applied to the SRS resources within each SRS resource set when at least one TCI codepoint is activated with two UL or joint TCI states. When the higher layer parameter is not configured for an SRS resource set, the first TCI state, the PL-RS associated with the first TCI state, and the UL power control parameter set for SRS associated with the first TCI state shall be applied to all the SRS resources within the SRS resource set.

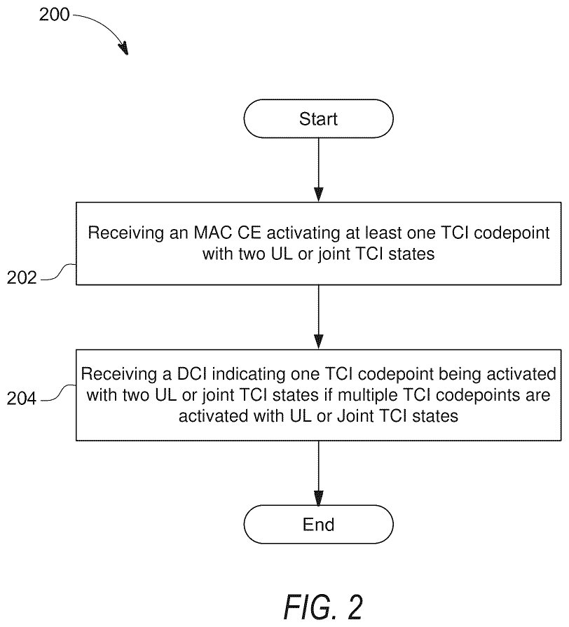

FIG. 2 is a schematic flow chart diagram illustrating an embodiment of a method 200 according to the present application. In some embodiments, the method 200 is performed by an apparatus, such as a remote unit (e.g. UE). In certain embodiments, the method 200 may be performed by a processor executing program code, for example, a microcontroller, a microprocessor, a CPU, a GPU, an auxiliary processing unit, a FPGA, or the like.

The method 200 is a method of a UE, comprising: 202 receiving an MAC CE activating at least one TCI codepoint with two UL or joint TCI states; and 204 receiving a DCI indicating one TCI codepoint being activated with two UL or joint TCI states if multiple TCI codepoints are activated with UL or joint TCI states. Each of the activated UL or joint TCI state can be associated with a PL-RS for downlink pathloss calculation, and be associated with at least one of UL power control parameter set for PUSCH, UL power control parameter set for PUCCH, and UL power control parameter set for SRS. The method may further comprise determining a TCI state, applying the determined TCI state and the PL-RS associated with the determined TCI state to each of PUSCH transmission(s), PUCCH transmission(s), and SRS transmission(s), applying the UL power control parameter set for PUSCH associated with the determined TCI state to the PUSCH transmission(s), applying the UL power control parameter set for PUCCH associated with the determined TCI state to the PUCCH transmission(s), and applying the UL power control parameter set for SRS associated with the determined TCI state to the SRS transmission(s), wherein, the determined TCI state is a first TCI state or a second TCI state of the two UL or joint TCI states activated to the only one TCI codepoint or the indicated one TCI codepoint.

In some embodiment, when only one SRS resource set used for codebook or non-codebook is configured, the first TCI state of the two joint TCI states is determined for all PUSCH transmissions.

In some embodiment, when two SRS resource sets used for codebook or non-codebook are configured, the first TCI state is associated with a first SRS resource set and the second TCI state is associated with a second SRS resource set, and the first TCI state is determined for the PUSCH transmissions transmitted on the SRS port(s) of the SRS resources contained in the first SRS resource set, and the second TCI state is determined for the PUSCH transmissions transmitted on the SRS port(s) of the SRS resources contained in the second SRS resource set. Depending on different types of the PUSCH transmission, the TCI state is determined differently. If the CG configuration of type 1 CG PUSCH transmission contains one group of srs-ResourceIndicator and precodingAndNumberOfLayers, the first TCI state is determined for the type 1 CG PUSCH transmission. If the CG configuration of type 1 CG PUSCH transmission contains two groups of srs-ResourceIndicator and precodingAndNumberOfLayers, the first TCI state is determined for the type 1 CG PUSCH transmission corresponding to a first group of srs-ResourceIndicator and precodingAndNumberOfLayers, and the second TCI state is determined for the type 1 CG PUSCH transmission corresponding to a second group of srs-ResourceIndicator and precodingAndNumberOfLayers. The first TCI state is determined for PUSCH transmission scheduled by DCI without SRS resource set indication field or type 2 CG PUSCH transmission activated by DCI without SRS resource set indication field. For a PUSCH transmission with repetition Type A or repetition Type B that is a dynamic grant PUSCH transmission scheduled by a DCI with SRS resource set indication field or a type 2 configured grant PUSCH transmission activated by a DCI with SRS resource set indication field, the TCI state is determined according to the value indicated by the SRS resource set indication field, wherein, if the PUSCH transmission is with repetition Type A, a repetition of the PUSCH transmission is one repetition of the PUSCH transmission transmitted in one slot, and if the PUSCH transmission is with repetition Type B, a repetition of the PUSCH transmission is a nominal repetition of the PUSCH transmission. When the SRS resource set indication field indicates a value “00”, the first TCI state is determined for all repetitions of the PUSCH transmission. When the SRS resource set indication field indicates a value “01”, the second TCI state is determined for all repetitions of the PUSCH transmission. When the SRS resource set indication field indicates a value “10”: when repetition number K=2, the first TCI state is determined for the first repetition of the PUSCH transmission, and the second TCI state is determined for the second repetition of the PUSCH transmission; when repetition number K>2 and cyclicMapping is configured, the first TCI state is determined for the first repetition of the PUSCH transmission, and the second TCI state is determined for the second repetition of the PUSCH transmission, and the same TCI state mapping pattern continues to the remaining repetitions of the PUSCH transmission; and when repetition number K>2 and sequentialMapping is configured, the first TCI state is determined for the first repetition and the second repetition of the PUSCH transmission, and the second TCI state is determined for the third repetition and the fourth repetition of the PUSCH transmission, and the same TCI state mapping pattern continues to the remaining repetitions of the PUSCH transmission. When the SRS resource set indication field indicates a value “11”: when repetition number K=2, the second TCI state is determined for the first repetition of the PUSCH transmission, and the first TCI state is determined for the second repetition of the PUSCH transmission; when repetition number K>2 and cyclicMapping is configured, the second TCI state is determined for the first repetition of the PUSCH transmission, and the first TCI state is determined for the second repetition of the PUSCH transmission, and the same TCI state mapping pattern continues to the remaining repetitions of the PUSCH transmission; and when repetition number K>2 and sequentialMapping is configured, the second TCI state is determined for the first repetition and the second repetition of the PUSCH transmission, and the first TCI state is determined for the third repetition and the fourth repetition of the PUSCH transmission, and the same TCI state mapping pattern continues to the remaining repetitions of the PUSCH transmission.

In some embodiments, for a PUCCH resource configured to be repeatedly transmitted in two slots or subslots, the first TCI state is determined for a first PUCCH repetition, and the second TCI state is determined for a second PUCCH repetition.

In some embodiments, for a PUCCH resource configured to be repeatedly transmitted in four or eight slots or subslots: when cyclicMapping is configured, the first TCI state is determined for a first PUCCH repetition, and the second TCI state is determined for a second PUCCH repetition, and the same TCI mapping pattern continues to the remaining PUCCH repetitions; and when sequentialMapping is configured, the first TCI state is determined for a first PUCCH repetition and a second PUCCH repetition, and the second TCI state is determined for a third PUCCH repetition and a fourth PUCCH repetition, and the same TCI mapping pattern continues to the remaining PUCCH repetitions.

In some embodiments, when only one SRS resource set for CB or nCB is configured, the first TCI state of the two joint TCI states is determined for the one SRS resource set.

In some embodiments, when two SRS resource sets for CB or nCB are configured, the first TCI state is determined for a first SRS resource set, and the second TCI state is determined for a second SRS resource set.

In some embodiments, for SRS resource sets for beam management or antenna switching without configured or indicated TCI state or spatial relation info, a higher layer parameter is configured per SRS resource set to determine the TCI state, or the first TCI state is determined for all SRS resources within a SRS resource set if no higher layer parameter is configured for the SRS resource set to determine the TCI state.

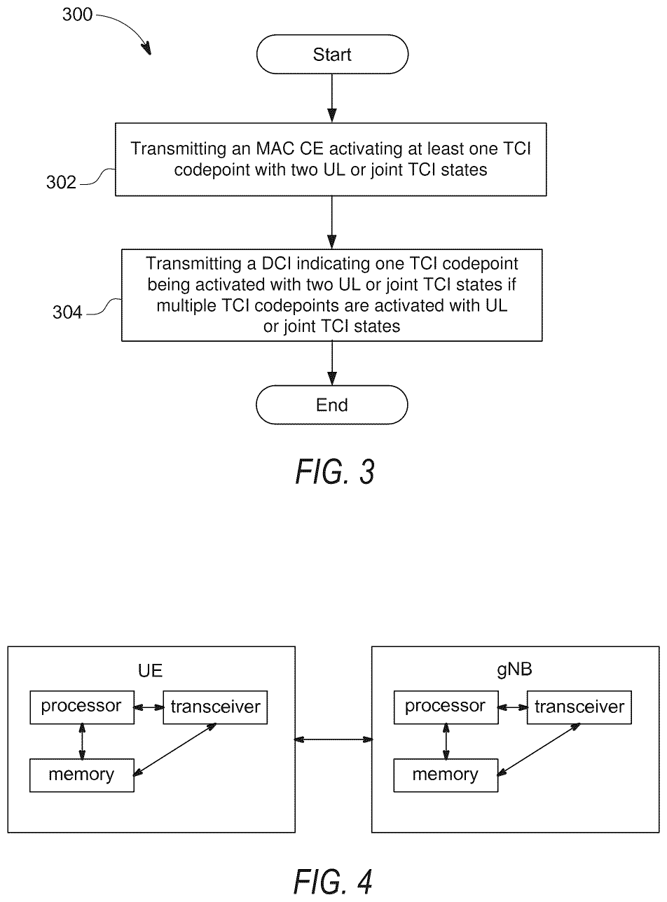

FIG. 3 is a schematic flow chart diagram illustrating an embodiment of a method 300 according to the present application. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may comprise: 302 transmitting an MAC CE activating at least one TCI codepoint with two UL or joint TCI states; and 304 transmitting a DCI indicating one TCI codepoint being activated with two UL or joint TCI states if multiple TCI codepoints are activated with UL or joint TCI states. Each of the activated UL or joint TCI state can be associated with a PL-RS for downlink pathloss calculation, and be associated with at least one of UL power control parameter set for PUSCH, UL power control parameter set for PUCCH, and UL power control parameter set for SRS. The method may further comprise determining a TCI state, determining that the determined TCI state and the PL-RS associated with the determined TCI state are applied to each of PUSCH transmission(s), PUCCH transmission(s), and SRS transmission(s), and determining that the UL power control parameter set for PUSCH associated with the determined TCI state is applied to the PUSCH transmission(s), the UL power control parameter set for PUCCH associated with the determined TCI state is applied to the PUCCH transmission(s), and the UL power control parameter set for SRS associated with the determined TCI state is applied to the SRS transmission(s), wherein, the determined TCI state is a first TCI state or a second TCI state of the two UL or joint TCI states activated to the only one TCI codepoint or the indicated one TCI codepoint.

In some embodiments, when only one SRS resource set used for codebook or non-codebook is configured, the first TCI state of the two joint TCI states is determined for all PUSCH transmissions.

In some embodiments, when two SRS resource sets used for codebook or non-codebook are configured, the first TCI state is associated with a first SRS resource set and the second TCI state is associated with a second SRS resource set, and the first TCI state is determined for the PUSCH transmissions transmitted on the SRS port(s) of the SRS resources contained in the first SRS resource set, and the second TCI state is determined for the PUSCH transmissions transmitted on the SRS port(s) of the SRS resources contained in the second SRS resource set. Depending on different types of the PUSCH transmission, the TCI state is determined differently. If the CG configuration of type 1 CG PUSCH transmission contains one group of srs-ResourceIndicator and precodingAndNumberOfLayers, the first TCI state is determined for the type 1 CG PUSCH transmission. If the CG configuration of type 1 CG PUSCH transmission contains two groups of srs-ResourceIndicator and precodingAndNumberOfLayers, the first TCI state is determined for the type 1 CG PUSCH transmission corresponding to a first group of srs-ResourceIndicator and precodingAndNumberOfLayers, and the second TCI state is determined for the type 1 CG PUSCH transmission corresponding to a second group of srs-ResourceIndicator and precodingAndNumberOfLayers. The first TCI state is determined for PUSCH transmission scheduled by DCI without SRS resource set indication field or type 2 CG PUSCH transmission activated by DCI without SRS resource set indication field. For a PUSCH transmission with repetition Type A or repetition Type B that is a dynamic grant PUSCH transmission scheduled by a DCI with SRS resource set indication field or a type 2 configured grant PUSCH transmission activated by a DCI with SRS resource set indication field, the TCI state is determined according to the value indicated by the SRS resource set indication field, wherein, if the PUSCH transmission is with repetition Type A, a repetition of the PUSCH transmission is one repetition of the PUSCH transmission transmitted in one slot, and if the PUSCH transmission is with repetition Type B, a repetition of the PUSCH transmission is a nominal repetition of the PUSCH transmission. When the SRS resource set indication field indicates a value “00”, the first TCI state is determined for all repetitions of the PUSCH transmission; when the SRS resource set indication field indicates a value “01”, the second TCI state is determined for all repetitions of the PUSCH transmission; when the SRS resource set indication field indicates a value “10”: when repetition number K=2, the first TCI state is determined for the first repetition of the PUSCH transmission, and the second TCI state is determined for the second repetition of the PUSCH transmission; when repetition number K>2 and cyclicMapping is configured, the first TCI state is determined for the first repetition of the PUSCH transmission, and the second TCI state is determined for the second repetition of the PUSCH transmission, and the same TCI state mapping pattern continues to the remaining repetitions of the PUSCH transmission; and when repetition number K>2 and sequentialMapping is configured, the first TCI state is determined for the first repetition and the second repetition of the PUSCH transmission, and the second TCI state is determined for the third repetition and the fourth repetition of the PUSCH transmission, and the same TCI state mapping pattern continues to the remaining repetitions of the PUSCH transmission; and when the SRS resource set indication field indicates a value “11”: when repetition number K=2, the second TCI state is determined for the first repetition of the PUSCH transmission, and the first TCI state is determined for the second repetition of the PUSCH transmission; when repetition number K>2 and cyclicMapping is configured, the second TCI state is determined for the first repetition of the PUSCH transmission, and the first TCI state is determined for the second repetition of the PUSCH transmission, and the same TCI state mapping pattern continues to the remaining repetitions of the PUSCH transmission; and when repetition number K>2 and sequentialMapping is configured, the second TCI state is determined for the first repetition and the second repetition of the PUSCH transmission, and the first TCI state is determined for the third repetition and the fourth repetition of the PUSCH transmission, and the same TCI state mapping pattern continues to the remaining repetitions of the PUSCH transmission.

In some embodiments, for a PUCCH resource configured to be repeatedly transmitted in two slots or subslots, the first TCI state is determined for a first PUCCH repetition, and the second TCI state is determined for a second PUCCH repetition.

In some embodiments, for a PUCCH resource configured to be repeatedly transmitted in four or eight slots or subslots, when cyclicMapping is configured, the first TCI state is determined for a first PUCCH repetition, and the second TCI state is determined for a second PUCCH repetition, and the same TCI mapping pattern continues to the remaining PUCCH repetitions; and when sequentialMapping is configured, the first TCI state is determined for a first PUCCH repetition and a second PUCCH repetition, and the second TCI state is determined for a third PUCCH repetition and a fourth PUCCH repetition, and the same TCI mapping pattern continues to the remaining PUCCH repetitions.

In some embodiments, when only one SRS resource set for CB or nCB is configured, the first TCI state of the two joint TCI states is determined for the one SRS resource set.

In some embodiments, when two SRS resource sets for CB or nCB are configured, the first TCI state is determined for a first SRS resource set, and the second TCI state is determined for a second SRS resource set.

In some embodiments, for SRS resource sets for beam management or antenna switching without configured or indicated TCI state or spatial relation info, a higher layer parameter is configured per SRS resource set to determine the TCI state, or the first TCI state is determined for all SRS resources within a SRS resource set if no higher layer parameter is configured for the SRS resource set to determine the TCI state.

FIG. 4 is a schematic block diagram illustrating apparatuses according to one embodiment.

Referring to FIG. 4, the UE (i.e. the remote unit) includes a processor, a memory, and a transceiver. The processor implements a function, a process, and/or a method which are proposed in FIG. 2.

The UE comprises a processor; and a receiver coupled to the processor, wherein the processor is configured to receive, via the receiver, an MAC CE activating at least one TCI codepoint with two UL or joint TCI states; and receive, via the receiver, a DCI indicating one TCI codepoint being activated with two UL or joint TCI states if multiple TCI codepoints are activated with UL or joint TCI states. Each of the activated UL or joint TCI state can be associated with a PL-RS for downlink pathloss calculation, and be associated with at least one of UL power control parameter set for PUSCH, UL power control parameter set for PUCCH, and UL power control parameter set for SRS. The processor is further configured to determine a TCI state, apply the determined TCI state and the PL-RS associated with the determined TCI state to each of PUSCH transmission(s), PUCCH transmission(s) and SRS transmission(s), and apply the UL power control parameter set for PUSCH associated with the determined TCI state to the PUSCH transmission(s), apply the UL power control parameter set for PUCCH associated with the determined TCI state to the PUCCH transmission(s), and apply the UL power control parameter set for SRS associated with the determined TCI state to the SRS transmission(s), wherein, the determined TCI state is a first TCI state or a second TCI state of the two UL or joint TCI states activated to the only one TCI codepoint or the indicated one TCI codepoint.

In some embodiment, when only one SRS resource set used for codebook or non-codebook is configured, the first TCI state of the two joint TCI states is determined for all PUSCH transmissions.

In some embodiment, when two SRS resource sets used for codebook or non-codebook are configured, the first TCI state is associated with a first SRS resource set and the second TCI state is associated with a second SRS resource set, and the first TCI state is determined for the PUSCH transmissions transmitted on the SRS port(s) of the SRS resources contained in the first SRS resource set, and the second TCI state is determined for the PUSCH transmissions transmitted on the SRS port(s) of the SRS resources contained in the second SRS resource set. Depending on different types of the PUSCH transmission, the TCI state is determined differently. If the CG configuration of type 1 CG PUSCH transmission contains one group of srs-ResourceIndicator and precodingAndNumberOfLayers, the first TCI state is determined for the type 1 CG PUSCH transmission. If the CG configuration of type 1 CG PUSCH transmission contains two groups of srs-ResourceIndicator and precodingAndNumberOfLayers, the first TCI state is determined for the type 1 CG PUSCH transmission corresponding to a first group of srs-ResourceIndicator and precodingAndNumberOfLayers, and the second TCI state is determined for the type 1 CG PUSCH transmission corresponding to a second group of srs-ResourceIndicator and precodingAndNumberOfLayers. The first TCI state is determined for PUSCH transmission scheduled by DCI without SRS resource set indication field or type 2 CG PUSCH transmission activated by DCI without SRS resource set indication field. For a PUSCH transmission with repetition Type A or repetition Type B that is a dynamic grant PUSCH transmission scheduled by a DCI with SRS resource set indication field or a type 2 configured grant PUSCH transmission activated by a DCI with SRS resource set indication field, the TCI state is determined according to the value indicated by the SRS resource set indication field, wherein, if the PUSCH transmission is with repetition Type A, a repetition of the PUSCH transmission is one repetition of the PUSCH transmission transmitted in one slot, and if the PUSCH transmission is with repetition Type B, a repetition of the PUSCH transmission is a nominal repetition of the PUSCH transmission. When the SRS resource set indication field indicates a value “00”, the first TCI state is determined for all repetitions of the PUSCH transmission; when the SRS resource set indication field indicates a value “01”, the second TCI state is determined for all repetitions of the PUSCH transmission; when the SRS resource set indication field indicates a value “10”: when repetition number K=2, the first TCI state is determined for the first repetition of the PUSCH transmission, and the second TCI state is determined for the second repetition of the PUSCH transmission; when repetition number K>2 and cyclicMapping is configured, the first TCI state is determined for the first repetition of the PUSCH transmission, and the second TCI state is determined for the second repetition of the PUSCH transmission, and the same TCI state mapping pattern continues to the remaining repetitions of the PUSCH transmission; and when repetition number K>2 and sequentialMapping is configured, the first TCI state is determined for the first repetition and the second repetition of the PUSCH transmission, and the second TCI state is determined for the third repetition and the fourth repetition of the PUSCH transmission, and the same TCI state mapping pattern continues to the remaining repetitions of the PUSCH transmission; and when the SRS resource set indication field indicates a value “11”: when repetition number K=2, the second TCI state is determined for the first repetition of the PUSCH transmission, and the first TCI state is determined for the second repetition of the PUSCH transmission; when repetition number K>2 and cyclicMapping is configured, the second TCI state is determined for the first repetition of the PUSCH transmission, and the first TCI state is determined for the second repetition of the PUSCH transmission, and the same TCI state mapping pattern continues to the remaining repetitions of the PUSCH transmission; and when repetition number K>2 and sequentialMapping is configured, the second TCI state is determined for the first repetition and the second repetition of the PUSCH transmission, and the first TCI state is determined for the third repetition and the fourth repetition of the PUSCH transmission, and the same TCI state mapping pattern continues to the remaining repetitions of the PUSCH transmission.

In some embodiments, for a PUCCH resource configured to be repeatedly transmitted in two slots or subslots, the first TCI state is determined for a first PUCCH repetition, and the second TCI state is determined for a second PUCCH repetition.

In some embodiments, for a PUCCH resource configured to be repeatedly transmitted in four or eight slots or subslots: when cyclicMapping is configured, the first TCI state is determined for a first PUCCH repetition, and the second TCI state is determined for a second PUCCH repetition, and the same TCI mapping pattern continues to the remaining PUCCH repetitions; and when sequentialMapping is configured, the first TCI state is determined for a first PUCCH repetition and a second PUCCH repetition, and the second TCI state is determined for a third PUCCH repetition and a fourth PUCCH repetition, and the same TCI mapping pattern continues to the remaining PUCCH repetitions.

In some embodiments, when only one SRS resource set for CB or nCB is configured, the first TCI state of the two joint TCI states is determined for the one SRS resource set.

In some embodiments, when two SRS resource sets for CB or nCB are configured, the first TCI state is determined for a first SRS resource set, and the second TCI state is determined for a second SRS resource set.

In some embodiments, for SRS resource sets for beam management or antenna switching without configured or indicated TCI state or spatial relation info, a higher layer parameter is configured per SRS resource set to determine the TCI state, or the first TCI state is determined for all SRS resources within a SRS resource set if no higher layer parameter is configured for the SRS resource set to determine the TCI state.

The gNB (i.e. the base unit) includes a processor, a memory, and a transceiver. The processor implements a function, a process, and/or a method which are proposed in FIG. 3.

The base unit comprises a processor and a transmitter coupled to the processor, wherein the processor is configured to transmit, via the transmitter, an MAC CE activating at least one TCI codepoint with two UL or joint TCI states; and transmit, via the transmitter, a DCI indicating one TCI codepoint being activated with two UL or joint TCI states if multiple TCI codepoints are activated with UL or joint TCI states.

Each of the activated UL or joint TCI state can be associated with a PL-RS for downlink pathloss calculation, and be associated with at least one of UL power control parameter set for PUSCH, UL power control parameter set for PUCCH, and UL power control parameter set for SRS. The processor may further be configured to determine a TCI state, determine that the determined TCI state and the PL-RS associated with the determined TCI state are applied to each of PUSCH transmission(s), PUCCH transmission(s) and SRS transmission(s), and determine that the UL power control parameter set for PUSCH associated with the determined TCI state is applied to the PUSCH transmission(s), the UL power control parameter set for PUCCH associated with the determined TCI state is applied to the PUCCH transmission(s), and the UL power control parameter set for SRS associated with the determined TCI state is applied to the SRS transmission(s), wherein, the determined TCI state is a first TCI state or a second TCI state of the two UL or joint TCI states activated to the only one TCI codepoint or the indicated one TCI codepoint.

In some embodiments, when only one SRS resource set used for codebook or non-codebook is configured, the first TCI state of the two joint TCI states is determined for all PUSCH transmissions.

In some embodiments, when two SRS resource sets used for codebook or non-codebook are configured, the first TCI state is associated with a first SRS resource set and the second TCI state is associated with a second SRS resource set, and the first TCI state is determined for the PUSCH transmissions transmitted on the SRS port(s) of the SRS resources contained in the first SRS resource set, and the second TCI state is determined for the PUSCH transmissions transmitted on the SRS port(s) of the SRS resources contained in the second SRS resource set. Depending on different types of the PUSCH transmission, the TCI state is determined differently. If the CG configuration of type 1 CG PUSCH transmission contains one group of srs-ResourceIndicator and precodingAndNumberOfLayers, the first TCI state is determined for the type 1 CG PUSCH transmission. If the CG configuration of type 1 CG PUSCH transmission contains two groups of srs-ResourceIndicator and precodingAndNumberOfLayers, the first TCI state is determined for the type 1 CG PUSCH transmission corresponding to a first group of srs-ResourceIndicator and precodingAndNumberOfLayers, and the second TCI state is determined for the type 1 CG PUSCH transmission corresponding to a second group of srs-ResourceIndicator and precodingAndNumberOfLayers. The first TCI state is determined for PUSCH transmission scheduled by DCI without SRS resource set indication field or type 2 CG PUSCH transmission activated by DCI without SRS resource set indication field. For a PUSCH transmission with repetition Type A or repetition Type B that is a dynamic grant PUSCH transmission scheduled by a DCI with SRS resource set indication field or a type 2 configured grant PUSCH transmission activated by a DCI with SRS resource set indication field, the TCI state is determined according to the value indicated by the SRS resource set indication field, wherein, if the PUSCH transmission is with repetition Type A, a repetition of the PUSCH transmission is one repetition of the PUSCH transmission transmitted in one slot, and if the PUSCH transmission is with repetition Type B, a repetition of the PUSCH transmission is a nominal repetition of the PUSCH transmission. When the SRS resource set indication field indicates a value “00”, the first TCI state is determined for all repetitions of the PUSCH transmission; when the SRS resource set indication field indicates a value “01”, the second TCI state is determined for all repetitions of the PUSCH transmission; when the SRS resource set indication field indicates a value “10”: when repetition number K=2, the first TCI state is determined for the first repetition of the PUSCH transmission, and the second TCI state is determined for the second repetition of the PUSCH transmission; when repetition number K>2 and cyclicMapping is configured, the first TCI state is determined for the first repetition of the PUSCH transmission, and the second TCI state is determined for the second repetition of the PUSCH transmission, and the same TCI state mapping pattern continues to the remaining repetitions of the PUSCH transmission; and when repetition number K>2 and sequentialMapping is configured, the first TCI state is determined for the first repetition and the second repetition of the PUSCH transmission, and the second TCI state is determined for the third repetition and the fourth repetition of the PUSCH transmission, and the same TCI state mapping pattern continues to the remaining repetitions of the PUSCH transmission; and when the SRS resource set indication field indicates a value “11”: when repetition number K=2, the second TCI state is determined for the first repetition of the PUSCH transmission, and the first TCI state is determined for the second repetition of the PUSCH transmission; when repetition number K>2 and cyclicMapping is configured, the second TCI state is determined for the first repetition of the PUSCH transmission, and the first TCI state is determined for the second repetition of the PUSCH transmission, and the same TCI state mapping pattern continues to the remaining repetitions of the PUSCH transmission; and when repetition number K>2 and sequentialMapping is configured, the second TCI state is determined for the first repetition and the second repetition of the PUSCH transmission, and the first TCI state is determined for the third repetition and the fourth repetition of the PUSCH transmission, and the same TCI state mapping pattern continues to the remaining repetitions of the PUSCH transmission.

In some embodiments, for a PUCCH resource configured to be repeatedly transmitted in two slots or subslots, the first TCI state is determined for a first PUCCH repetition, and the second TCI state is determined for a second PUCCH repetition.

In some embodiments, for a PUCCH resource configured to be repeatedly transmitted in four or eight slots or subslots: when cyclicMapping is configured, the first TCI state is determined for a first PUCCH repetition, and the second TCI state is determined for a second PUCCH repetition, and the same TCI mapping pattern continues to the remaining PUCCH repetitions; and when sequentialMapping is configured, the first TCI state is determined for a first PUCCH repetition and a second PUCCH repetition, and the second TCI state is determined for a third PUCCH repetition and a fourth PUCCH repetition, and the same TCI mapping pattern continues to the remaining PUCCH repetitions.

In some embodiments, when only one SRS resource set for CB or nCB is configured, the first TCI state of the two joint TCI states is determined for the one SRS resource set.

In some embodiments, when two SRS resource sets for CB or nCB are configured, the first TCI state is determined for a first SRS resource set, and the second TCI state is determined for a second SRS resource set.

In some embodiments, for SRS resource sets for beam management or antenna switching without configured or indicated TCI state or spatial relation info, a higher layer parameter is configured per SRS resource set to determine the TCI state, or the first TCI state is determined for all SRS resources within a SRS resource set if no higher layer parameter is configured for the SRS resource set to determine the TCI state.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, the UE comprising:
a processor;
a memory coupled to the processor; and
a receiver coupled to the processor;
wherein the processor is configured to cause the UE to:
receive, via the receiver, a medium access control (MAC) control element (CE) activating at least one Transmission Configuration Indication (TCI) codepoint with two uplink (UL) or joint TCI states; and
receive, via the receiver, a downlink control information (DCI) indicating one TCI codepoint being activated with two UL or joint TCI states if multiple TCI codepoints are activated with UL or joint TCI states.

2. The UE of claim 1, wherein;
each of the activated UL or joint TCI state is associated with a pathloss reference signal (PL-RS) for downlink pathloss calculation, and is associated with at least one of UL power control parameter set for physical uplink shared channel (PUSCH), UL power control parameter set for physical uplink control channel (PUCCH), and UL power control parameter set for sounding reference signal (SRS); and
the processor is further configured to:
determine a TCI state;
apply the determined TCI state and the PL-RS associated with the determined TCI state to each of PUSCH transmission(s), PUCCH transmission(s) and SRS transmission(s);
apply the UL power control parameter set for PUSCH associated with the determined TCI state to the PUSCH transmission(s);
apply the UL power control parameter set for PUCCH associated with the determined TCI state to the PUCCH transmission(s); and
apply the UL power control parameter set for SRS associated with the determined TCI state to the SRS transmission(s);
wherein, the determined TCI state is a first TCI state or a second TCI state of the two UL or joint TCI states activated to the only one TCI codepoint or the indicated one TCI codepoint.

3. The UE of claim 2, wherein, when only one SRS resource set used for codebook or non-codebook is configured, the first TCI state of the two joint TCI states is determined for all PUSCH transmissions.

4. The UE of claim 2, wherein, when two SRS resource sets used for codebook or non-codebook are configured;
the first TCI state is associated with a first SRS resource set and the second TCI state is associated with a second SRS resource set;
the first TCI state is determined for the PUSCH transmissions transmitted on the SRS port(s) of the SRS resources contained in the first SRS resource set; and
the second TCI state is determined for the PUSCH transmissions transmitted on the SRS port(s) of the SRS resources contained in the second SRS resource set.

5. The UE of claim 4, wherein, if the configured grant (CG) configuration of type 1 CG PUSCH transmission contains one group of srs-ResourceIndicator and precodingAndNumberOfLayers, the first TCI state is determined for the type 1 CG PUSCH transmission.

6. The UE of claim 4, wherein, if the CG configuration of type 1 CG PUSCH transmission contains two groups of srs-ResourceIndicator and precodingAndNumberOfLayers, the first TCI state is determined for the type 1 CG PUSCH transmission corresponding to a first group of srs-ResourceIndicator and precodingAndNumberOfLayers, and the second TCI state is determined for the type 1 CG PUSCH transmission corresponding to a second group of srs-ResourceIndicator and precodingAndNumberOfLayers.

7. The UE of claim 4, wherein, the first TCI state is determined for PUSCH transmission scheduled by DCI without SRS resource set indication field or type 2 CG PUSCH transmission activated by DCI without SRS resource set indication field.

8. The UE of claim 4, wherein, for a PUSCH transmission with repetition Type A or repetition Type B that is a dynamic grant PUSCH transmission scheduled by a DCI with SRS resource set indication field or a type 2 configured grant PUSCH transmission activated by a DCI with SRS resource set indication field;
when the SRS resource set indication field indicates a value “00”, the first TCI state is determined for all repetitions of the PUSCH transmission;
when the SRS resource set indication field indicates a value “01”, the second TCI state is determined for all repetitions of the PUSCH transmission;
when the SRS resource set indication field indicates a value “10”;
when repetition number K=2, the first TCI state is determined for the first repetition of the PUSCH transmission, and the second TCI state is determined for the second repetition of the PUSCH transmission;
when repetition number K>2 and cyclicMapping is configured, the first TCI state is determined for the first repetition of the PUSCH transmission, the second TCI state is determined for the second repetition of the PUSCH transmission, and the same TCI state mapping pattern continues to the remaining repetitions of the PUSCH transmission; and
when repetition number K>2 and sequentialMapping is configured, the first TCI state is determined for the first repetition and the second repetition of the PUSCH transmission, the second TCI state is determined for the third repetition and the fourth repetition of the PUSCH transmission, and the same TCI state mapping pattern continues to the remaining repetitions of the PUSCH transmission; and
when the SRS resource set indication field indicates a value “11”;
when repetition number K=2, the second TCI state is determined for the first repetition of the PUSCH transmission, and the first TCI state is determined for the second repetition of the PUSCH transmission;
when repetition number K>2 and cyclicMapping is configured, the second TCI state is determined for the first repetition of the PUSCH transmission, the first TCI state is determined for the second repetition of the PUSCH transmission, and the same TCI state mapping pattern continues to the remaining repetitions of the PUSCH transmission; and
when repetition number K>2 and sequentialMapping is configured, the second TCI state is determined for the first repetition and the second repetition of the PUSCH transmission, the first TCI state is determined for the third repetition and the fourth repetition of the PUSCH transmission, and the same TCI state mapping pattern continues to the remaining repetitions of the PUSCH transmission,
wherein, if the PUSCH transmission is with repetition Type A, a repetition of the PUSCH transmission is one repetition of the PUSCH transmission transmitted in one slot, and if the PUSCH transmission is with repetition Type B, a repetition of the PUSCH transmission is a nominal repetition of the PUSCH transmission.

9. The UE of claim 2, wherein, for a PUCCH resource configured to be repeatedly transmitted in two slots or subslots, the first TCI state is determined for a first PUCCH repetition, and the second TCI state is determined for a second PUCCH repetition.

10. The UE of claim 2, wherein, for a PUCCH resource configured to be repeatedly transmitted in four or eight slots or subslots;
when cyclicMapping is configured, the first TCI state is determined for a first PUCCH repetition, the second TCI state is determined for a second PUCCH repetition, and the same TCI mapping pattern continues to the remaining PUCCH repetitions; and
when sequentialMapping is configured, the first TCI state is determined for a first PUCCH repetition and a second PUCCH repetition, the second TCI state is determined for a third PUCCH repetition and a fourth PUCCH repetition, and the same TCI mapping pattern continues to the remaining PUCCH repetitions.

11. The UE of claim 2, wherein, when only one SRS resource set for codebook or non-codebook is configured, the first TCI state of the two joint TCI states is determined for the one SRS resource set.

12. The UE of claim 2, wherein, when two SRS resource sets for codebook or non-codebook are configured, the first TCI state is determined for a first SRS resource set, and the second TCI state is determined for a second SRS resource set.

13. The UE of claim 2, wherein, for SRS resource sets for beam management or antenna switching without configured or indicated TCI state or spatial relation info, a higher layer parameter is configured per SRS resource set to determine the TCI state, or the first TCI state is determined for all SRS resources within a SRS resource set if no higher layer parameter is configured for the SRS resource set to determine the TCI state.

14-15. (canceled)

16. A processor for wireless communication, the processor configured to:
receive a medium access control (MAC) control element (CE) activating at least one Transmission Configuration Indication (TCI) codepoint with two uplink (UL) or joint TCI states; and
receive a downlink control information (DCI) indicating one TCI codepoint being activated with two UL or joint TCI states if multiple TCI codepoints are activated with UL or joint TCI states.

17. The processor of claim 16, wherein:
each of the activated UL or joint TCI state is associated with a pathloss reference signal (PL-RS) for downlink pathloss calculation, and is associated with at least one of UL power control parameter set for physical uplink shared channel (PUSCH), UL power control parameter set for physical uplink control channel (PUCCH), and UL power control parameter set for sounding reference signal (SRS); and
the processor is further configured to:
determine a TCI state;
apply the determined TCI state and the PL-RS associated with the determined TCI state to each of PUSCH transmission(s), PUCCH transmission(s) and SRS transmission(s);
apply the UL power control parameter set for PUSCH associated with the determined TCI state to the PUSCH transmission(s);
apply the UL power control parameter set for PUCCH associated with the determined TCI state to the PUCCH transmission(s); and
apply the UL power control parameter set for SRS associated with the determined TCI state to the SRS transmission(s);
wherein, the determined TCI state is a first TCI state or a second TCI state of the two UL or joint TCI states activated to the only one TCI codepoint or the indicated one TCI codepoint.

18. The processor of claim 17, wherein, when two SRS resource sets used for codebook or non-codebook are configured:
the first TCI state is associated with a first SRS resource set and the second TCI state is associated with a second SRS resource set;
the first TCI state is determined for the PUSCH transmissions transmitted on the SRS port(s) of the SRS resources contained in the first SRS resource set; and
the second TCI state is determined for the PUSCH transmissions transmitted on the SRS port(s) of the SRS resources contained in the second SRS resource set.

19. A method of wireless communication by a user equipment (UE), the method comprising:
receiving a medium access control (MAC) control element (CE) activating at least one Transmission Configuration Indication (TCI) codepoint with two uplink (UL) or joint TCI states; and
receiving a downlink control information (DCI) indicating one TCI codepoint being activated with two UL or joint TCI states if multiple TCI codepoints are activated with UL or joint TCI states.

20. The method of claim 19, wherein:
each of the activated UL or joint TCI state is associated with a pathloss reference signal (PL-RS) for downlink pathloss calculation, and is associated with at least one of UL power control parameter set for physical uplink shared channel (PUSCH), UL power control parameter set for physical uplink control channel (PUCCH), and UL power control parameter set for sounding reference signal (SRS); and
the method further comprises:
determining a TCI state;
applying the determined TCI state and the PL-RS associated with the determined TCI state to each of PUSCH transmission(s), PUCCH transmission(s) and SRS transmission(s);
applying the UL power control parameter set for PUSCH associated with the determined TCI state to the PUSCH transmission(s);
applying the UL power control parameter set for PUCCH associated with the determined TCI state to the PUCCH transmission(s); and
applying the UL power control parameter set for SRS associated with the determined TCI state to the SRS transmission(s);
wherein, the determined TCI state is a first TCI state or a second TCI state of the two UL or joint TCI states activated to the only one TCI codepoint or the indicated one TCI codepoint.

21. A base unit for wireless communication, the base unit comprising:
a processor;
a memory coupled to the processor; and
a transmitter coupled to the processor;
wherein the processor is configured to cause the base unit to:
transmit, via the transmitter, a medium access control (MAC CE) activating at least one Transmission Configuration Indication (TCI) codepoint with two uplink (UL) or joint TCI states; and
transmit, via the transmitter, a downlink control information (DCI) indicating one TCI codepoint being activated with two UL or joint TCI states if multiple TCI codepoints are activated with UL or joint TCI states.

22. The base unit of claim 21, wherein:
each of the activated UL or joint TCI state is associated with a pathloss reference signal (PL-RS) for downlink pathloss calculation, and is associated with at least one of UL power control parameter set for physical uplink shared channel (PUSCH), UL power control parameter set for physical uplink control channel (PUCCH), and UL power control parameter set for sounding reference signal (SRS); and
the processor is configured to cause the base unit to:
determine a TCI state;
determine that the determined TCI state and the PL-RS associated with the determined TCI state are applied to each of PUSCH transmission(s), PUCCH transmission(s) and SRS transmission(s); and
determine that the UL power control parameter set for PUSCH associated with the determined TCI state is applied to the PUSCH transmission(s), the UL power control parameter set for PUCCH associated with the determined TCI state is applied to the PUCCH transmission(s), and the UL power control parameter set for SRS associated with the determined TCI state is applied to the SRS transmission(s);
wherein, the determined TCI state is a first TCI state or a second TCI state of the two UL or joint TCI states activated to the only one TCI codepoint or the indicated one TCI codepoint.
